(19) United States
(12) Patent Application Publication
(10) Pub. No.: US 2018/0325121 A1
(43) Pub. Date: Nov. 15, 2018

(54) Insect Attractant And Eradicant

(71) Applicants: Travis Jay Keller, Soldotna, AK (US); Michael Wayne Arnold, Sterling, AK (US)

(72) Inventors: Travis Jay Keller, Soldotna, AK (US); Michael Wayne Arnold, Sterling, AK (US)

(21) Appl. No.: 15/978,187

(22) Filed: May 13, 2018

Related U.S. Application Data
(60) Provisional application No. 62/506,497, filed on May 15, 2017.

(51) Int. Cl. A01N 65/44; A01N 65/22; A01N 65/28

(52) U.S. Cl. CPC A01N 65/44; A01N 65/28; A01N 65/22

(57) ABSTRACT

An insect attractant and eradicant composition providing two part insect control. Insects are drawn to a centralized attractant and as such removes their presence, annoyance, and harm from areas surrounding the attractant. The insecticidal properties associated with the attractant and eradicant composition then immobilizes and kills the insects for terminal removal from the area. The composition is made from essential oils and common household components for a non-toxic formulation to humans and animals, but retaining high insecticide effectiveness. The design of the composition and the dispenser provide for continuous and effective attractant properties through extreme deployment conditions and a dispenser that is capable of small to large numbers of insects. The composition was developed for commercial agricultural use, and is well suited for residential, agriculture, and other commercial and non-commercial applications as it is a safe and benign composition of non-toxic essential oils and other common household components.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### COPYRIGHT STATEMENT

All of the material in this patent application and subsequent patent documents are subject to copyright protection under the copyright laws of the United States and other countries. The copyright owner has no objection to the reproduction of a patent, patent application, or invention disclosure if retained as a complete document as published by the copyright owner, government, or found in a government record. Otherwise all other copyright provisions whatsoever are reserved.

### BACKGROUND OF THE INVENTION

### Field of the Invention

This disclosure relates to the use of one or more insect attractants to draw insects to a composition with insecticide properties for insect eradication.

### Problem Statement

The impetus for this discovery was based on attempts to reduce produce waste caused by insect bites and assaults that made the appearance and integrity of the produce in the field less marketable. There are many examples where the presence of one to numerous insects can adversely impact the health, safety, quality of life, and wellbeing of humans, animals, and in the above example even the integrity and acceptability of produce.

Specifically, and where appropriate, the minimization and even elimination of insects is necessary as insects often go beyond simply being an annoyance, to being potentially painful as well as often being vectors for carrying diseases from bacteria, viruses, pathogens, protozoan's, and organisms to humans and animals. As previously mentioned they also can do hard in other economic ways.

Insect control has long been addressed by effective insecticides for commercial, residential, agricultural, and in open land uses. Insecticides are often categorized into several broad categories based on compound moieties, to include: carbonates, organ chlorine, organophosphates, and pyrethrums. Insecticides are intended to kill insects and operate by direct and indirect contact, ingestion, tracheae inhalation or suffocation, starvation, drowning, and other mechanical action. Direct application includes such actions as direct spray, food compositions, coatings, vapors, and more. Indirect application includes such actions as pretreated surface transfers to insects, “systemic” incorporation in plant cells and material, starvation, suffocation, and other methods.

It is the intended purpose of these insecticides to have a biocide function for the size and structure of insects and not for larger living mass. However, many of these insecticides can be poisons with human and animal toxicity given enough incident or reoccurring exposure. Further, the use of these and other pervasive chemistries has over time lead to some increased chemical concentrations in soil, water, and the atmosphere. This increased specific and general physiologically and non-physiologically chemical exposure has created insecticide and other human and animal chemical sensitivities throughout society. This exposure is not just measureable by analytical instrumentation, but sensed and manifested with increasing physiological reactions such as headaches, upset stomachs, and foul odors, and more serious health symptoms to name a few. As such, in the case of insecticides and like chemistries, the Environmental Protection Agency (EPA) under the Federal Insecticide, Fungicide, and Rodentcide Act (FIFRA) regulates the use of identified toxic ingredients for insecticides and pesticides, among other products.

There continue to be a need to finding effective, but less toxic insecticide alternatives for general use as well as for direct human and animal contact applications where insects may reside on or in the skin and hair. One such general class of effective alternatives is the insecticidal function of many essential oils whether natural or synthetically derived. The term “essential” attached to an organic oil or oil of a plant means the oil contains the essence or characteristic of the source, plant, or specific area of the source or plant (bark, fruit or berry, flower, leaves, peel, resin, rhizome, root, seeds, wood, etc.). The term essential oils in this disclosure is inclusive of natural essential oils and pure and blended synthetic oils with substantially similar insecticidal, insecticidal enhancement, and other associated natural essential oil properties.

Unlike conventional insecticides with often absolute efficacy at sufficient concentration and exposure, the use of essential oils is less understood and not always explicitly accepted as efficacious. Required is more confirmatory experimentation to validate and optimize lethal efficacy. Many of these essential oils are not regulated by the EPA under FIFRA as they are not considered poisonous for humans and animals, even small children and pets, while still maintaining insecticidal function. More so with natural essential oils, they may be composed of numerous compounds hundreds of compounds. Unlike a conventional natural and synthetic insecticide compounds the bioactivity of essential oils may not be attributed to one or more of the major compounds, but may also involve other constituents or their influence upon other compounds in the essential oil. These additional chemical constituents may also include excipients, carriers, surfactants, volatiles, and other inerts. The natural and synthetic essential oils and associated compounds are extracted from plants and other natural raw material sources. Essential oils currently not regulated by FIFRA include, but not limited to, cornmint oil, cedar oil, cinnamon oil, citronella oil, clove oil, corn oil, garlic oil, lemongrass oil, linseed oil, peppermint oil, rosemary oil, soybean oil, thyme oil, citrus oils, and others.

More continues to be known about the mechanisms of insecticidal action of essential oils with the prominent insecticidal assault being on the insect neurological system. Whether by ingestion, aspiration, or by simple contact, the efficacy of insecticidal mechanisms are enhanced by other associated components within the essential oil or available from the inclusion of other essential and associated components, surfactants or soaps, excipients and solvents, and other enhancers. These enhancers often operate by removing or increasing the penetrability of waxy layer or other protective coatings on the insect resulting in enhanced penetration of essential oils through the exoskeleton and tissue uptake, weaken cell membranes, provide for dehydration, and other related mechanisms.

Although not considered an essential oil, oils such as mineral oil also can contribute to insecticide function. Other oils considered to more or less suitable properties similar to those of mineral oil can include, but not limited to, canola oil, castor oil, corn oil, cottonseed oil, fish oil, neem oil, olive oil, peanut oil, safflower oil, soybean oil, sunflower oil, among others. Consideration of these oils not only considers their chemistry, but other properties of odor, color, viscosity, stability, cost, among other considerations. Mineral oil is often ascribed to encapsulate respiratory function, promote penetration of other natural and synthetic active compounds, provides a residual efficacy, retains volatile compounds of some essential oils, and otherwise raises the efficacy of an insecticide composition.

Like conventional insecticides that may be more or less effective on different insects, a use consideration of essential oils for insecticidal properties is recognizing an expected selective efficacy on different insects. A combination of essential oils may create the specific properties sought for attracting, repelling, altering behavior, or exterminating insects.

The problem identified and resolved by this disclosure is an attractant and eradicant compositions non-toxic to humans and animals that attracts local insects, quickly immobilizes them, and ultimately eradicates them. In one preferred embodiment, achieved is the minimization of insect assaults on produce that improves the appearance and integrity of produce for increased harvest yield and market acceptance. The attractant and eradicant further provides minimization of insects in the vicinity of the delivery system to free humans and animals of insect annoyance, discomfort and pain, and potentially associated health concerns.

The following disclosure addresses various means of providing effective compositions that attract and eradicate insects from an area within the vicinity of the composition delivery system.

### State of the Art Assessment

The use of essential oils in insecticide applications as shown in the following patents is expressive of the current state of essential oil based insecticide compositions and the current state of their means of application. In these documents, the essential oil based compositions may be used for repellant, insecticide, or both purposes.

The disclosure made herein will be referred to as (Keller 2017) and solves the problem of insect annoyance and assault by means of attracting the insect to the eradicant thus clearing or minimizing the presence and damaging results of insects in a vicinity. Based on essential oils not listed on the EPAs FIFRA list, this non-toxic composition to humans and animals of all sizes is an eradicant of insects that are shown to be immobilized in the immediate vicinity of the attractant and the eradicated by death.

This disclosure represents a typical oil based composition category for human skin applied repellent spray and soap for tick post-attachment treatment in U.S. Pat. No. 8,674,684 B2 published Aug. 1, 2013 to Howard Baube, MA, USA (Baube 2013) discussing compositions having essential oils with insecticidal properties applied in the form of a non-irritating repellent spray (col 7 line 5) and a non-irritating repellent/insecticidal soap (col 7 line 12). Central to this disclosure are formulations pH balanced to reduce irritation when skin contact is made.

This disclosure represents water soluble composition category for human and animal skin applied insect treatment of U.S. Pat. No. 7,294,342 B2 published 15 Jan. 2004 by Michael Precopio (Precopio 2004) for treating ectoparasite infestations, or most commonly head lice. The composition is pesticide free and includes at least one monohydric aralkyl alcohol to limit the closing of ectoparasite respiratory systems while other components of the composition cause suffocation. Mechanisms of asphyxiation have included oil based occlusive treatments are effective, but can be difficult to remove after treatment. The problem solved by this disclosure is the use of water soluble air impermeable occlusive compositions.

This disclosure represents food based classification of insecticide composition category with a capture mechanism of JP 2012246273 A published 13 Dec. 2012 by Kazuaki Wakita (Wakita 2012) is used to control insects in areas needing food and human safety considerations. The use of a food based composition is to use in the composition in food oriented locations and as a vehicle for ingestion. The application is implied in the area of infestation. This disclosure suggested the use of food or food additives as a “main ingredient” with other insect killing constituents that are sprayed, injected, foamed, etc. such that a “hard stable bubble is formed” to capture the insect with presumably a liquid core or associated liquid to block the spiracle of the insect leading to death.

This disclosure represents plant applied insecticide spray and cream disclosed of CN 1267451 A published 27 Sep. 2000 to Wang Yuwan et al. (Yuwan 2000) using a conventional pesticide combined with mineral oil, among other components, to coat respiratory function, enhance pesticide compound penetration, and raise insecticide efficacy. Discussed are typical functions of mineral oil, other light oils, and presumably many natural essential oils. The method of application is spraying as well as mentioned is the form of a cream.

This disclosure represents the category of insecticides with an attractant based on plant essential oil applied to the target plant of CN105532762 A published 4 May 2016 by Mao Guofeng et.al (Guofeng 2016) is used as a non-toxic insecticide. The disclosure recognizes properties of essential oil volatiles that creates an attractant plume combined with the specific natural insecticide “enemy” of the rice planthopper or anagrus nilaparvatae.

This disclosure represents the category of insect treatments for soil and seed using plant extracts of KR 2009/0040269 A published 23 May 2009 by Lee Change Geun et.al (Geun 2009) for heated greenhouse insect control. Mixtures of essential oils applied as a plant spray or soil treatment for insecticide and disinfectant purposes.

This disclosure represents the type of general repelling, controlling, and directing insects of pollinating and non-pollinating insects of US 2014/0274683 A1 published 18 Sep. 2014 by Tai-Teh WU et.al (Wu 2014) using repellent compounds. No insecticidal function was disclosed, but using mechanisms of repelling, directing away, and controlling away from a desired location of treatment.

The above disclosures represent common classes of insect control and extermination applications relevant to this field of inquiry. The following table summarizes the state of the art:

TABLE 1

| | | | Be- | | | Non- | | | | | | | | Infes- | |
|---|---|---|---|---|---|---|---|---|---|---|---|---|---|---|---|
| | | | hav- | | Poison- | Poision- | | | | | | | Creams/ | tation | |
| | At- | Re- | ior | | Based | Based | Skin | Spray/ | | Wet | | Wet | Oint- | Area | Area- |
| | tract- | pel- | Mod- | Insec- | Insec- | Insec- | and | Aero- | | Then | | Then | ments/ | Treat- | Treat |
| Application | ant | lent | ifier | ticide | ticide | ticide | Hair | solized | Dry | Dry | Wet | Moist | Soaps | ment | ment |
| Baube 2013 | | X | | X | | X | X | X | | | | | X | X | |
| Precopio 2004 | | | | X | X | X | X | | | | | | X | X | |
| Wakita 2012 | | | | X | X | X | | X | X | | | X | | X | |
| Yuwan 2000 | | | | X | X | X | | X | | X | | | X | X | |
| Guofeng 2016 | X | | | X | | X | | X | | X | | | | X | |
| Geun 2009 | | | | X | | X | | X | | | | X | | X | |
| Wu 2014 | | X | X | X | X | X | | | | | | | | X | |
| Keller 2017 | X | | X | X | | X | | | | | X | | | | X |

It is acknowledged that there are years and a host of knowledge in the area of repellents, insecticides, pesticides, and other insect and pest mitigators using conventional compound based bioactive agents. However, this disclosure is only concerned with essential oil based insecticides. Analysis of the above referenced documents and disclosures, represents types of classes of repellents and insecticides using some form of non-poisonous to human and animal compositions. Shown are compositions and applications used as sprays, solids, and ointments for skin and hair uses, plant vegetation to root treatments, soil and seed treatments, and indoor and outdoor infestation sites uses

Looking at the summary table, what is left unaddressed is an area insect eradicator that operates by attracting insects to a centralized insecticide, without the need to spread insecticide across an area. At this centralized insecticide dispenser insects are swiftly immobilized and eradicated resulting in the removal or minimization of insects in a local area. Further, unaddressed is the deployment of an insecticide in its most effective form, or that of a liquid. This disclosure presents an unexpected efficacy in insecticide performance by attracting insects to an insecticide source presented in the most effective form where the liquid is ingested and wets the insect for swift immobilization and ultimately eradication.

### BRIEF SUMMARY OF THE INVENTION

The development of this attractant and eradicant was developed due to local influences upon a produce agricultural operation. As fruit and vegetable operation a significant quality factor is the integrity of the natural peel or skin covering of the fruit to protect against contamination, premature rot, as well as visual appearance. Insect assault on produce can breach the integrity of the natural covering of produce reducing the viability of the produce and general commercial value.

As this agricultural operation is located on the edge of a vast national forest it is unwarranted and unfeasible to treat sufficient surrounding acreage of forest vegetation and lands to eradicate all or selective insects most harmful to the produce. Further, it would be unwise to seek the elimination of such a vast number of insects from the adjacent natural habitat.

Consequently, a focus was placed on minimizing or eliminating the presence of insects within the confines of the agricultural operation. The solution however, must be robust enough to eradicate insects or selected insects at an ongoing basis as the adjacent forest reserve provides essentially an unlimited number of migrating insects to the produce under cultivation. There are plenty of agricultural insecticides and repellents, but none provided sufficient eradication on an ongoing basis. Many are applied and then become quickly diluted and ineffective with spray or furrow irrigation, morning dew, regular rain, wind, and other weather in this particular location, even if such chemistries are developed for these conditions. Although acceptable, use of chemical bioactives or poisons can be effective, but it is increasingly unacceptable commercially for produce, and contributes to the general environmental contamination and increasing social chemical sensitization, as well as suffers from a to rapid reduction in efficacy. Non-poisonous essential oil insecticide compositions applied to the soil, plants, and produce can be effective, but are applied as a thin dry or tacky film that can be effective if ingested, but there is too little to wet and often too high a viscosity to wet the insect's spiracles and tracheal system to be meaningful. Further such sprayed thin films more rapidly release essential oil insecticide contributing volatiles leaving the thin films less potent. As previously mentioned these non-poisonous essential oil insecticides are also degraded too rapidly by dilution and other mechanisms associated with the conditions previously mentioned.

The attractant and eradicant disclosed here addresses the problems identified. Those being a non-poisonous insecticide, area treatment, and continuous efficacy.

The attractant and eradicant is composed of select essential oils for their insecticide properties, without toxicity to humans and animals. Whether by natural origin or a synthetic likeness of any purity, essential oils provide for an attractant, an insecticide, or both attributes. These attributes may be derived from a single essential oil or combination of essential oils. The specific composition of essential oils disclosed herein show there may be a tailoring of the attractive properties to specific insects and tailors the insecticidal properties of the composition. Other additives are also used to enhance attractant properties as well as insecticidal property. Ultimately this non-toxic composition is more commercially acceptable than those using conventional insecticide and does not contribute to chemical proliferation in the environment.

Area treatment by attracting insects to a centralized insecticide dispenser provides a unique delivery method among insecticide application methods. It is the general practice to take the insecticide to the insects. Applying the insecticide to nesting locations, at insect corridors, near food sources, in soils, on seeds, on plants, on the skin or in the hair, across fields and open space as some application examples. For insects with higher mobility, treating an area with a centralized attractant and eradicant provides the ideal insecticide. A centralized attractant and eradicant minimizes or eliminates the need to distribute chemicals and composition whether bioactive or bioinert. Centralizing the attractant and eradicant refers to keeping such chemistry contained in dispensers where they can be controlled, managed, removed, relocated, refreshed, cleared of insects which is also a visual indicator or on-going effectiveness, and other such activities, and any of their combinations. The deployment of such centralized dispensers of attractant and eradicant may include, but not limited to residential, animal, or commercial enclosed facility; areas about a facility; fields; grounds, gardens, orchards; recreational areas, and other areas that may be annoyed or harmed by the presence of insections. The application of the attractant and eradicant to clear an agricultural area, recreation area, residential area, animal areas, and other application does not require putting the insecticide in the middle of the activity to repel insects where fumes, vapors, sprays, ointments, powders, coated surfaces, more point of infestation application methods create an annoyance to a hazard. Rather, insects are drawn away from the area with the insecticide also distant from the area of interests or in large area applications at certain points distributed as needed across the area.

Insecticide efficacy is a central consideration. Chemical potency almost universally improves with granularization for increased reactive surface area. Naturally this increases from solids, powders, to liquids then vapors and gases. Solid insecticides interact with insects by ingestion and physical transfer by contact. Insecticides can also be formed as a food item, often a solid, that is usually limited to the mechanism of ingestion and not expected to be effective by simple contact. Solids also often take the form of a thin film or layer commonly from a spray application on surfaces, areas of infestation, on plants, another areas. Often these formulations result in a dried insecticide form that can be effective, but more limited than a vapor, gas, or even liquid. A way of optimize insecticides is to distribute them as a vapor, fog, and fine droplet to allow for wide area distribution. The severe limiting factor of vapors, gases, mists, fogs, and other like forms is their temporary residency. It is apparent that a most effective form of insecticide or repellent delivery is to use a liquid form. The other form of insecticide application is that in liquid form. A liquid application can mean spraying at an insect, but this can be only marginally effective and can use a vast amount of composition. A key element to the effectiveness of this disclosure is its contained or controlled delivery in liquid form. The liquid form provides many advantages. The insecticide becomes more bioavailable more contact available than a solid, and more resident to the point of application than a vapor, gas, and other volatile forms. As a result of increased ingestion bioavailability, increased contact availability, and increased residency of the insecticide in the more available form observed was sufficiently rapid immobilization of the insects such that they do not leave the insecticide dispensing area and ultimately eradicated where immobilized. A further important feature of this disclosure is the retained effectiveness, without degradation due to season appropriate weather conditions or delivery system design. This disclosure remains effective in continually attracting insects to the insecticide, even when there is essentially a vast available population of insects to continually migrate and assault the area and object of interest and potentially overwhelm the insecticide dispenser.

The necessity of a different way to mitigate and minimize insect presence and assault on an area and items is shown as needed. More specific disclosure follows as to how the innovations and unexpected results of this invention fulfill this demonstrated need. A need with the unique combination of deployment conditions of limiting distribution of a poisonous composition to humans and animals, providing enhanced efficacy for sufficiently immediate insect immobilization and eradication to retain centralization of insects, and provide a robust composition and system that will not be overwhelmed by usual and extreme insect conditions.

### BRIEF DESCRIPTION OF THE SEVERAL VIEWS OF THE DRAWING

FIG. 1—Mechanisms Of Insect Eradication represents possible mechanisms leading to rapid immobilization of the insect and ultimate eradication.

FIG. 2—Sustained Attractant And Eradicant represents the effectiveness of the composition and delivery to attract and eradicate large numbers of insects over a sustained period of time.

FIG. 3—Flow chart representing the components, order of addition, and basic process in forming the Attractant And Eradicant Concentrate Composition.

FIG. 4—Flow chart representing the formation of the Stable Syrup Solution used as the delivery medium of the attractant and eradicant.

FIG. 5—Flow chart representing the final deployment solution of Attractant And Eradicant Deployment Solution in a dispenser.

FIG. 6—Selective Attractant And Eradicant represents the effectiveness of the composition and delivery to attract and eradicate specific insects.

### DETAILED DESCRIPTION OF THE INVENTION

### Principles of the Invention

The impetus of innovation leverages the most avenues of insect eradication available at the biological, material liquid phase, chemical characteristics, spatial, and mechanical realms.

Biologically, the disclosure leverages the mobility of insects to be attracted to a central insecticide to extract the insect assault and annoyance from an area of interest in proximity to the attractant. Biologically, the liquid form of the attractant and eradicant is the most immediately available to the insect for ingestion and then bioavailability for the most immediate immobilization and eradication by internal physiological mechanisms. The liquid form of the attractant and eradicant also most readily wets, coats, and fully or partially seals the insect's spiracles leading to tracheal suffocation as a contributor to external immobilization and eradication. The liquid form of the attractant and eradicant also provides a physical immobilizer by wetting and coating the body, legs, wings, and other elements that immobilize and disorient the insect.

The liquid phase of the attractant and eradicant has partially been expressed as its most preferred insect intake with usually the most bioavailability for the most immediate immobilization and eradication, as well as its ability to wet and coat the insect for additional mechanisms of immobilization and eradication. The liquid form also provides for relatively simple deployment of the attractant and eradicant solution. Further, the liquid format of the solution makes for a more facile diffusion of attractive constituents to the surface of the solution for more consistent emanation of the attractants from the centralized solution. The use of a liquid for of the attractant and eradicant is a deliberate inventive element of this disclosure.

The spatial properties of this disclosure leverages the ability of insect mobility to centralize the attractant and insecticide composition to draw insects to the composition, rather than spread the composition in the environment and in direct contact to humans, animals, their food and habitat. Centralizing the insecticide chemistry and chemistry generally, reducing unnecessary chemical exposure and increase the ease of deployment as well as retrieval to remove the chemistry from deployment. Leveraging the centralized deployment of the insecticide by attracting insects is a deliberate and inventive component of this disclosure.

The chemical characteristics found in essential oils provides from both an insect attractant to draw the insects to an insecticide, but also provide the insecticide function. Further, although some essential oils provide an effective insecticide property, many are not considered and are regulatory classified as non-poisonous to humans and animals. The use of essential oils to exploit these properties in a new and unexpected manner is a central element of this disclosure.

The mechanical aspects of the invention deliberately associated with the invention are at least two fold. As previously disclosed, there is the physical or mechanical aspect of weighting down the body, legs, wings, and other insect function by the weight, tackiness, and other impediments of the liquid on the insect. A further aspect of the invention is the form of physical or mechanical delivery of the attractant and insecticide. It is expressly innovated that to be fully available to the insect for internal ingestion and for external impediment. A current best mode of the invention is to present the attractant and eradicant in a liquid form and in a simple open container, such as a bucket, tub, can, and the like. In addition to a free liquid surface, equivalently effective has been observed to be a saturated substrate, such as wood, cloth, sponge, soil, and the like. Further, presenting the liquid form of the attractant and eradicant to the insect may be through a controlled delivery device that provides liquid for insect ingestion, external application, and their combination. Having a centralized and mechanical delivery form allows for deploying the attractant and eradicant solution when needed and removed when not needed. For instance, there is no need for the attractant and eradicant during the early part of the season of planting and growth, after harvest, when humans or animals may not be present, when other insects of value may be present, and other circumstances.

This disclosure presents separate inventive elements along with a combination of elements rising to inventive useful results for residential and commercial social segments. What follows are the specific inventive elements of this disclosure.

### Drawing Description

It will readily be understood by one having ordinary skill in the relevant art that the present disclosure has broad application and utility. Any disclosure discussed and identified as being “preferred” is considered to be part of a best mode of the present invention or improvement. Additional disclosures may be provided for illustrative purposes of scope and in providing a full and enabling disclosure. Adaptations, variations, modifications, equivalent, and similar arrangements are implicitly included in the explicit disclosures described herein and fall within the scope of the present invention and improvements.

The present invention is directed to overcoming one or more of the problems set forth above. In the following description of the various embodiments, reference is made to the accompanying drawings, which form a part hereof, and in which are shown by way of illustration various embodiments in which the invention may be practiced. It is to be understood that other embodiments may still be utilized and structural and functional modifications may be made without departing from the scope and spirit of the present of the present invention. The use and utility of the present invention is believed to be apparent from the drawings, but a few descriptive words of the apparatus are added below for emphasis.

The following guidance is acknowledge and used with prudence. 608.01(a)(c)t.02(i) “Where elements or groups of elements, compounds, and processes, which are conventional and generally widely known in the field of the invention described, and their exact nature or type is not necessary for an understanding and use of the invention by a person skilled in the art, they should not be described in detail.”

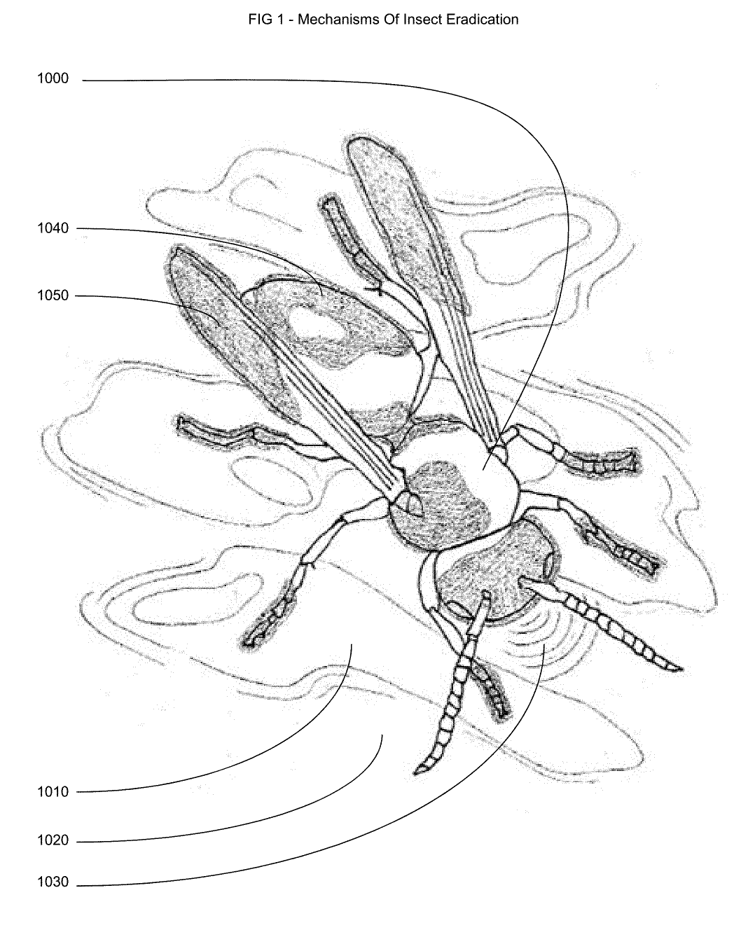

FIG. 1—Mechanisms Of Insect Eradication

FIG. 1 is a depiction of the attractant and eradicant composition being available to an insect for ingestion for internal mechanisms of eradication and wetting the insect for external mechanisms of eradication. Specifically depicted is a flying insect [1000], in this case most representative of what is commonly referred to as a Yellowjacket, only by way of example, and could be representative of any flying insect. Further this disclosure is not limited to flying insects, but is inclusive of any mobile insect that can reach a centralized distribution of eradicant directed by an attractant. The insect [1000] is shown to be on the surface of the solution by either the surface tension of the solution itself, or by some integrated structure or perch [1010]. The perch [1010] is any structure if needed or preferred by the insect [1000] to access the surface of the attractant and eradicant solution. As stated it may be the liquid itself or phase structure of the liquid. It could be organic debris such as leaf material, small twigs and stems, saw dust and chips, and other natural material or its derivatives. If often is the carcasses of other previously arriving insects, it may be the surface or structure of the open container. This perch may also be a design element of the attractant and eradicant delivery system be it a sponge or wicking material that is saturated or makes available pools of liquid, a perforated solid or semi-solid structure integrated with the liquid or that delivers the liquid to a surface, an orifice, droplet system, or other liquid accessible mechanisms. This illustration depicts a large liquid surface [1020] depicted as the undefined space in the illustration around the perch [1010] and the insect [1000]. The liquid in this disclosure being specifically discussed elsewhere in this discussion, but generally is an emulsified composition of essential oils in water.

FIG. 1 is now established with the context of the illustration, the mechanisms of eradication can be described. Important to this disclosure is the insecticidal action from a bioactive mechanism. It is known that essential oils have a neurotoxic physiological activity on the insect causing ultimate eradication. Ingestion [1030] of the liquid composition of the essential oils is a direct application of essential oils and their neurotoxic affect on the insect. The more bioavailable form of essential oils preserved in a liquid carrier make the neurotoxic components of the essential oils more effective and more rapidly effective. A surprising result of this invention is the rapid immobilizing of the insect, and then followed by eradication. Another eradicating mechanism is the wetting [1040] of the insect and resultant closure of the spiracles leading to tracheal suffocation. The general hydrophobic nature of the essential oils naturally wet the insect, but combined with emulsifiers this wetting, coating, and sealing property of the composition is enhanced. This may be a second method of eradication contributing to the significant effectiveness of the composition. Related to the wetting [1040] of the insect is the weighting [1050] of the insect with the solution. This refers to the added solution weight on the insect that impedes mobility and for flight insects the weight added to wings to impede flight. Included in this term of weighting [1050] is the recognizing that immobility may also be impacted by solution characteristics of tackiness, damage by chemical entities such as removal of protective coatings by emulsifiers in the solution, and other mechanisms.

FIG. 1 illustrates the effectiveness of an attractant that brings insects to a central location from which they are eradicated by one or more possible mechanism. Elsewhere in this disclosure are further specifics of this disclosure of an attractant and eradicant of insects.

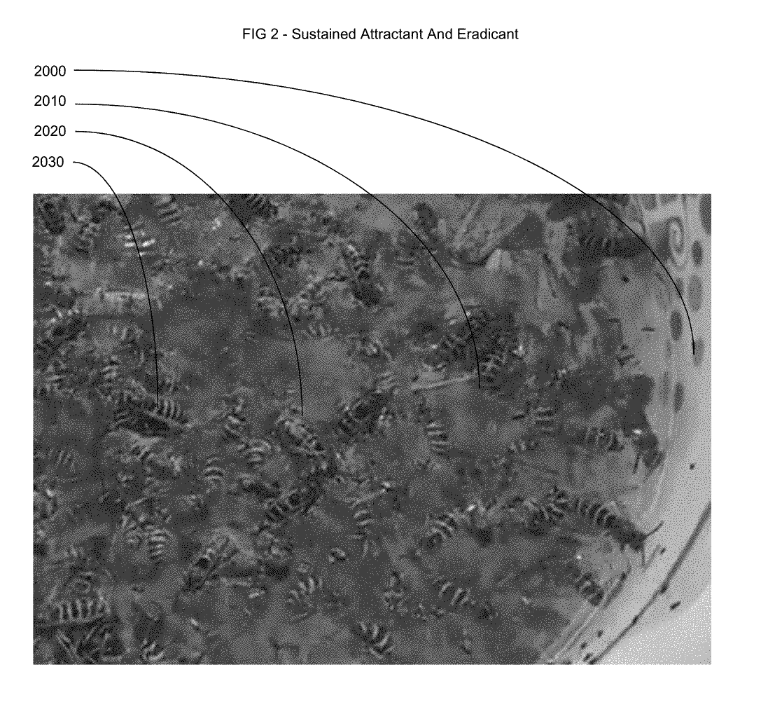

FIG. 2—Sustained Attractant And Eradicant

FIG. 2 is a photo illustrating the sustained effectiveness of the composition. The sustained effectiveness includes that of the composition. Shown is that the composition continues to provide an attractant or release of essential oil volatile components to lure into the centralized insecticide insects over time. This is a simple illustrative image with a dispenser [2000], in this illustration being a small plastic bucket, but could be any open top bucket, can, tub, or similar structure. By way of example, but limited to these specific forms, the dispense is found to also be effective as a saturated medium, such as: a board, sponge, cloth, soil, saw dust or other liquid suspending material, and other wicking material or material that can pool the composition and any of their combinations. This presentation of the liquid may also include by way of example, but not limited to these forms, to be an orifice or multiple orifice dispenser of a liquid, a mesh within or adjacent to the surface of the liquid, other liquid presenting methods and any of their combinations. Within the dispenser [2000] is shown the free liquid [2010] in this application. The freely available liquid [2010] in this case is shown to be populated with the carcasses many dead insects [2020] on the surface of the liquid and in the liquid as they are pushed down by the next arriving insects. This dispensing system provides for a sustainable effectiveness as illustrated by the live newly arrived insects [2030]. Demonstrated is the effectiveness of the composition to attract insects for a sustained period of time under broad weather use condition, as well as to effective insecticide properties sustain over the time of dispense [2000] deployment.

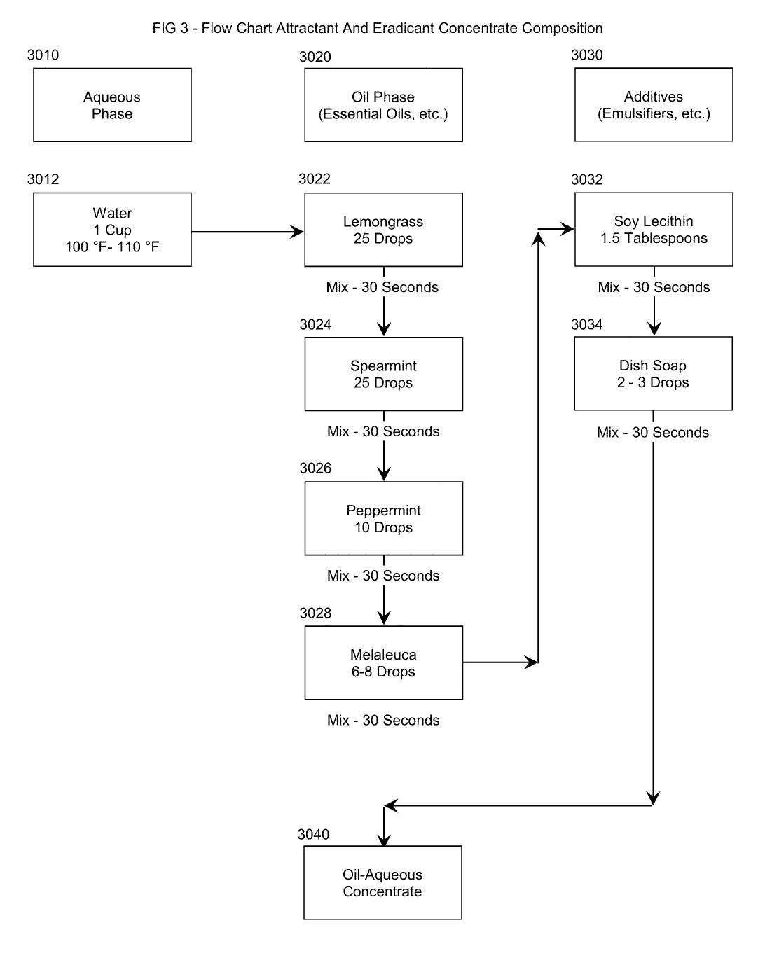

FIG. 3—Flow Chart of Attractant and Eradicant Concentrate Composition

FIG. 3 illustrates the structure of the composition of one embodiment of this disclosure. Noted is that the composition consists of three primary classes of constituents, those being an Aqueous Phase [3010], Oil Phase [3020], and Additives [3030]. Within the Aqueous Carrier [3010] is the first constituent of the formulation and that being Water [3012] of a small 1 cup volume held at a range of 100° F.-110° F. Upon this Water [4012] reaching the prescribed temperature, the Oil Phase [3020] is added with each oil sequentially. The order of oil addition may be changed, but currently follows as listed. Additionally, the addition of the oil phase first or adding the emulsifiers first may either occur. What follows is the first addition of the oil phase with the first being the essential oil of Lemongrass [3022] at a volume of 25 drops and stirred in for 30 seconds at a medium or moderate stir rate. The formulation is made under continuous mixing, with the designation of 30 seconds as simply representative of about the time to gather the next constituent to add, but the time may not critical to the properties of composition. The next essential oil being Spearmint [3024] at a volume of 25 drops followed by intermediate mixing at moderate speeds for a period about equal to preparing for the next addition. A third essential oil follows with Peppermint [3026] to an amount of 10 drops and again with moderate mixing in preparation for the fourth essential oil. That fourth being Melaleuca [3024] to an amount of 6 to 8 drops and again mixing until the next additives are prepared. Where compatible under immediate or longer term stability, two or more of the oils may be pre-mixed and added as a single component mix in forming the concentrate. It is acknowledged that at this point in the process there is largely a two phased system with those phases being mechanically integrated in some degree by moderate stirring. To more fully integrate the oil phase into the aqueous phase the Additives [3030] are added next. Although represented and described as following the addition of the oils or oil phase, it is equally suitable that the additives be incorporated into the composition before the oils or oil phase to assist in emulsifying the oils into the water phase. These last additions are emulsifiers and the first includes Soy Lecithin [3032] in small amounts until equal to an amount of 1.5 Tablespoons and mixed until the second additive is ready and position or about 30 seconds. Added is Dish Soap [3034] of 2-3 drops and continuously stirred through the final addition. The stir may increase in stir rate and duration as needed to sufficiently blend the emulsion.

FIG. 3 results an Oil-Aqueous Concentrate [3040] of essential oils in an aqueous suspension. The essential oils provide attractant properties with volatiles that now emanate from the emulsion and surface of the aqueous carrier that are sensed by insects. Further these essential oils and their various constituents also provide insecticide properties that show sufficiently swift properties to immobilize insects and ultimately eradicant properties.

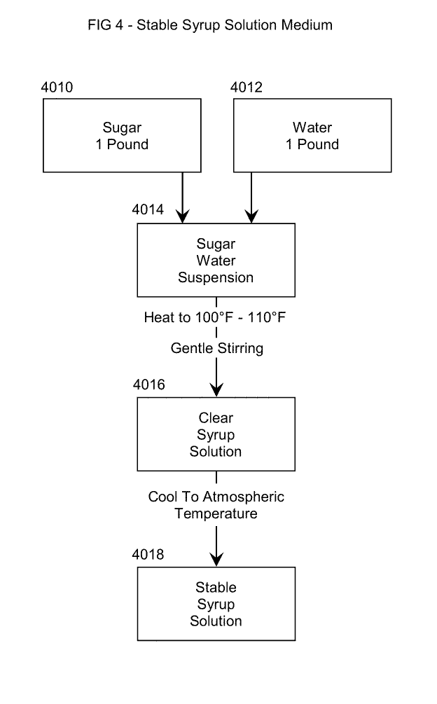

FIG. 4—Flow Chart of Sugar Solution Medium

FIG. 4 is a flow chart of the preparation of the sugar solution medium for dilution of the attractant and eradicant concentrate. A 1:1 solution is created. Show is a Sugar [4010] shown in a quantity equal to one pound and mixed with Water [4012] shown in an amount equal to one pound. The Sugar [4010] in this embodiment is a typical white granulated sugar, but is not limited to this form of sugar, but which may also include and not limited to corn syrup, high fructose corn syrup, fructose, cane sugar, syrups, molasses, and other effective sweetening attractants and any of their combinations. The Sugar [4010] and Water [4012] are mixed as a phase separated solid phase Sugar Suspension [4014] requiring heating and stirring to accelerate total dissolution of the sugar into the water. The current preferred temperature is 100° F.-110° F., or a temperature below the boiling of water. The Sugar Suspension [4014] is heated and stirred until it transforms into a clear Syrup Solution [4016] and then cooled to atmospheric temperature creating a Stable Syrup Solution [4018] and establishing a medium that will not be at a temperature that may degrade essential oils and other composition components.

FIG. 4 represents the bulk solution component of the attractant and eradicant and forms an important practical consideration of the application. The Oil Attractant And Eradicant Concentrate [3040] can be more readily commercially packaged with the Stable Syrup Solution [4018] prepared locally at or near the deployment location. The Stable Sugar Solution [4018] is another component providing a point of distribution attractant to retain the insect at the dispensing site and encouraging ingestion of the eradicant. The combination of spatial and local attractant of the essential oils and the local sugar attractant at the dispenser of this disclosure shows a significant behavior modifying solution to remain at the dispenser while neurological affects and eradication occur.

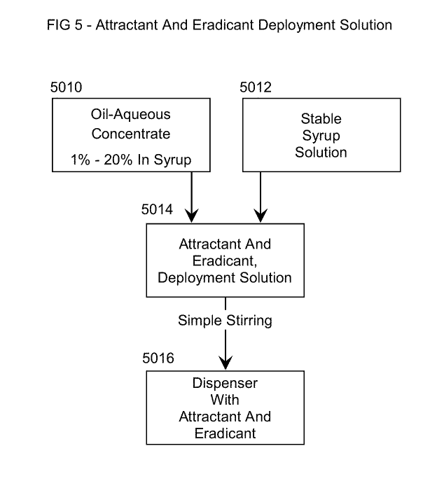

FIG. 5—Attractant And Eradicant Deployment Solution.

FIG. 5 discloses the final deployment solution of the attractant and eradicant. Show in a volume of the Oil Attractant And Eradicant Concentrate [5010] of ¼ Cup mixed by simple stirring with the Stable Syrup Solution [5012] to form the Attractant And Eradicant Syrup Deployment Solution [5014]. The incorporation of ¼ cup concentrate in 2.5 gallons or syrup solution is one embodiment, but the concentration may change from 1% to 20% of the Oil Attractant And Eradicant Concentrate [5010] in the Stable Syrup Solution [5012].

FIG. 5 discloses the simplicity of the deployment solution as an Oil Aqueous Concentrate [5010] readily dispersible in an aqueous Stable Syrup Solution [5012] for immediate deployment in one or more Dispensers with Attractant and Eradicant [5016]. In this embodiment, this is in the form of a simple open face container, which has been a small or large bucket, tub, can, or other similar container.

This disclosure results in an area insect mitigator or minimizer by attracting insects to a centralized attractant and eradicant. The specific details of this disclosure reveals a composition capable of continuous attractant signaling under various weather conditions, a continuous ideally effective immobilizer and eradicant and a dispenser capable of accommodating small to large number of insects. This disclosure provides a useful insect mitigator for human and animal purposes, agricultural purposes, and other residential and commercial application with rapid attractant and eradicant effectiveness facilitated by a mechanical device for centralized dispensing.

While the invention has been described with particular reference to the preferred embodiments, it will be understood by those skilled in the art that various changes may be made and equivalents may be substituted for elements of the preferred embodiments without departing from invention. For example, the tops of the partitions may be at the same elevation as the sidewall or may be lower for aesthetic appeal. It is accordingly intended that the claims shall cover all such modifications and applications as do not depart from the true spirit and scope of the invention.

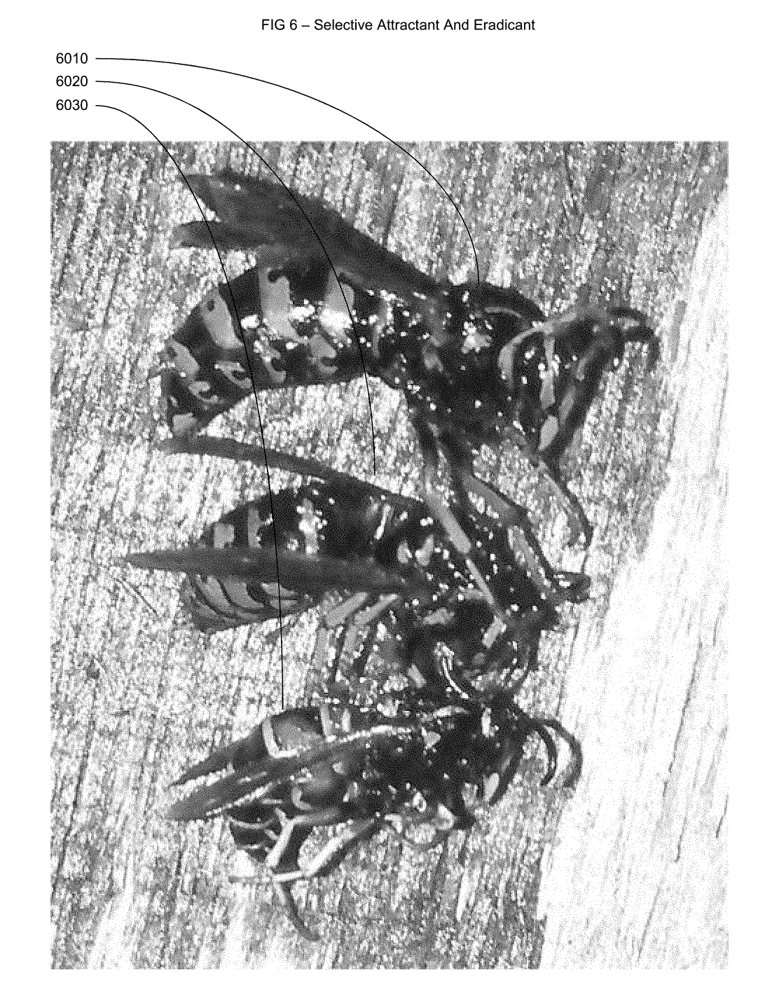

FIG. 6—Selective Attractant And Eradicant Specificity.

FIG. 6 discloses a field experiments held in the spring and summer of 2017 demonstrating the effectiveness of the invention to preserve a desired insect while attracting and eradicating undesirable insects in terms of commercial harm and health and discomfort to humans and animals. In April of 2017 two packages of honey bees were received. One species being the Italian honey bee and the second being the Carniolan honey bee. Each were placed in ten frame hive boxes elevated nine feet above the ground on top of a shipping container. They were fed with and open bucket solution of 1 to 1 by weight ratio of sugar to water. The solution was placed on the shipping container next to hives. In early May it was observed that wasps and other insect pests were also attracted by the food solution. An additional bucket of sugar and water feed solution was prepared and the attractant with eradicant invention concentrate was added to this new bucket of feed. It was also placed directly next to the hives and the other bucket of feed. After a few days It was observed that the wasps were attracted more to the new bucket of sugar and water feed solution with the Attractant with eradicant than the regular sugar and water original feed solution adjacently positioned. It was also observed that the bees remained primarily attracted to the original feed solution with few bees found in the sugar and water feed solution also containing the attractant and eradicant from the invention concentrate. Attracted and eradicated were many of what I refer to as Yellow Jacket wasps [6010] of considerable size dead and dying in the attractant and eradicant solution. It is suspected that these larger wasps were mostly Queens. The smaller Yellow Jackets [6020] were the most numerous and expected to be of the general wasp population. There was a different wasp [6030] that is not identified, but pictured to show range in selective attractant and eradication. There were also some common house flies. After a few weeks of feeding the buckets were removed along with their remaining contents, the original bee sugar and water feed was completely gone and there was about a third of a bucket with feed solution containing the attractant and eradicant with a few other insects and bugs. A result of the placement of the attractant and eradicant feed solution was a significant reduction in wasp activity at the Bee hives and surrounding locations. It is suggested that the larger wasps eradicated were Queens and in turn the populations of wasps were decimated before nests could be organized.

FIG. 6 shows the presence of different kind of wasp [6030] as a selectively attracted and eradicated insect. The spring 2017 deployment of attractant and eradicant in a sugar and water solution resulted in the eradication of numerous wasps, other wasps, flies, and bugs. In like manner, during the summer of 2017 in a hydroponic agriculture production facility of 7,000 strawberry plants it was noticed that the plant and fruit were being attacked by flies, professionally identified as Blowflies (not shown). The attractant and eradicant solution was placed in open containers at four different stations. Over the course of three days there was observed several thousand blowflies attracted and eradicated. Disclosed is another demonstration of the effectiveness of the invention solution, components, elements, and delivery in attracting and eradicating various insects, in this case what is commonly known as the Blowfly. As expected over the course of development and associated experimentation, other types of flies have been effectively attracted and efficiently eradicated.

While the invention has been described with particular reference to the preferred embodiments, it will be understood by those skilled in the art that various changes may be made and equivalents may be substituted for elements of the preferred embodiments without departing from invention. It is accordingly intended that the claims shall cover all such modifications and applications as do not depart from the true spirit and scope of the invention.

### General Interpretation

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The singular forms “a,” “an,” and “the” intend to denote “at least one,” include plurality forms as well, unless the context clearly dictates otherwise. Thus, for example, reference to “a particle” includes reference to one or more of such materials and reference to “subjecting” refers to one or more such steps.

As used herein to join a list of items, “or” indicates “at least one of the items,” but does not exclude a plurality of items from the list. Further, as used herein, to join a list of items, “and” denotes “all of the items of the list.” The term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y” As used herein, phrases such as “from about X to Y” mean “from about X to about Y”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context. References to a structure or feature that is disposed “adjacent” another feature may have portions that overlap or underlie the adjacent feature.

Spatially relative terms, such as “under, “below”, “lower, “over, “upper, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

As used herein with respect to an identified property or circumstance, “substantially” refers to a degree of deviation that is sufficiently small so as to not measurably detract from the identified property or circumstance. The exact degree of deviation allowable may in some cases depend on the specific context. The principle of “substantially” persists in the absence of the presence of the word itself or an equivalent. A further interpretation of the principle is that similar items need not be considered to be exact. This principle accounts for the fact that in the natural world there is not perfection, but that two or more properties can be considered the same in closeness away from deviation and be considered the same with some deviation present. Whether the word “substantially” or another equivalent word is present or not these two or more properties, items, or other elements are considered the same, unless specifically noted as different.

A plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps, sequence, or temporary order recited in any method or process claims are illustrative and not restrictive. Further, it is understood that steps, sequences, or temporary order of various processes or methods which may be shown and described may be executed in any order and are not limited to the order presented.

Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein.

In the figures, proportions, thickness of certain lines, layers, components, elements or features may be exaggerated for clarity.

1. An insect attractant and eradicant concentrate comprising:
one or more essential oils, and
one or more attractants, and
one or more eradicants, and
one or more emulsifiers, and
an aqueous medium.

2. The insect attractant and eradicant concentrate of claim 1 comprising essential oil of Lemongrass.

3. The insect attractant and eradicant concentrate of claim 1 comprising essential oil of Peppermint.

4. The insect attractant and eradicant concentrate of claim 1 comprising essential oil of Spearmint.

5. The insect attractant and eradicant concentrate of claim 1 comprising Melaleuca oil.

6. The insect attractant and eradicant concentrate of claim 1 comprising Lemongrass, Peppermint, and Spearmint oil mix.

7. The insect attractant and eradicant concentrate of claim 1 comprising Spearmint and Melaleuca oil mix.

8. The insect attractant and eradicant concentrate of claim 1 comprising Lemongrass, Spearmint, and Melaleuca oil mix.

9. The insect attractant and eradicant concentrate of claim 1 comprising Peppermint, Spearmint, and Melaleuca oil mix.

10. The insect attractant and eradicant concentrate of claim 1 comprising Lemongrass, Peppermint, Spearmint, and Melaleuca oil mix.

11. An insect attractant and eradicant concentrate comprising:
the essential oil of Spearmint, and
one or more additional essential oils, and
one or more emulsifiers, and
in an aqueous solution.

12. The insect attractant and eradicant concentrate of claim 9 comprising essential oil of Lemongrass.

13. The insect attractant and eradicant concentrate of claim 9 comprising essential oil of Peppermint.

14. The insect attractant and eradicant concentrate of claim 9 comprising Melaleuca oil.

15. The insect attractant and eradicant concentrate of claim 9 comprising Lemongrass and Peppermint oil mix.

16. The insect attractant and eradicant concentrate of claim 9 comprising Lemongrass and Melaleuca oil mix.

17. The insect attractant and eradicant concentrate of claim 9 comprising Peppermint and Melaleuca oil mix.

18. The insect attractant and eradicant concentrate of claim 9 comprising Lemongrass, Peppermint, and Melaleuca oil mix.

19. An insect attractant and eradicant concentrate deployment solution of claim 9, in which it is mixed at 1% to 20% in an aqueous sugar solution.

20. An insect attractant and eradicant concentrate comprising:
an aqueous medium, and
the essential oil of Lemongrass, and
the essential oil of Peppermint, and
the essential oil of Spearmint, and
one or more emulsifiers.

21. A deployment solution of claim 16 concentrate comprising dilution to 1% to 20% in an aqueous sugar solution.

22. An insect attractant and eradicant concentrate comprising:
an aqueous medium, and
the essential oil of Lemongrass, and
the essential oil of Peppermint, and
the essential oil of Spearmint, and
the Melaleuca oil, and
one or more emulsifiers.

23. A deployment solution of claim 18 concentrate comprising dilution of 1% to 20% in an aqueous sugar solution.
